(19) United States
(12) Patent Application Publication
(10) Pub. No.: US 2025/0362659 A1
(43) Pub. Date: Nov. 27, 2025

(54) ARTIFICIAL INTELLIGENCE BASED INDUSTRIAL SITE WORK AREA MINIMUM NUMBER-OF-PEOPLE CONTROL SYSTEM

(71) Applicant: INTER X Co., Ltd., Ulsan (KR)

(72) Inventors: MinChul KIM, Ulsan (KR); Ha Il JUNG, Ulsan (KR); Jung Ywn PARK, Ulsan (KR)

(21) Appl. No.: 19/206,742

(22) Filed: May 13, 2025

(30) Foreign Application Priority Data
May 21, 2024 (KR) 10-2024-0065908

(51) Int. Cl. G05B 19/4061; G06T 7/70; G06V 10/82; G06V 20/52; G06V 40/10

(52) U.S. Cl. CPC G05B 19/4061; G06T 7/70; G06V 10/82; G06V 20/52; G06V 40/10; G06T 2207/20081; G06T 2207/20084; G06T 2207/30196; G06T 2207/30232; G06T 2207/30242

(57) ABSTRACT

An artificial intelligence based industrial site work area minimum number-of-people control system according to an exemplary embodiment includes a camera which captures equipment which performs a process of producing products in an industrial site in real time to acquire real-time image data, a control unit which turns on or off the equipment, an image collection unit which collects the real-time image data acquired by the camera, an artificial intelligence inference unit which establishes an industrial site image dataset based on the real-time image data and trains, validates, and tests an artificial intelligence model to monitor a worker in the real-time image data based on the industrial site image dataset and calculate the number of workers detected by the monitoring, and a worker count unit which displays the real-time image data on a screen, sets an actual work area on the real-time image data displayed on the screen.

### CROSS-REFERENCE TO RELATED APPLICATIONS

This application claims the priority of Korean Patent Application No. 10-2024-0065908 filed on May 21, 2024, in the Korean Intellectual Property Office, the disclosure of which is incorporated herein by reference.

### BACKGROUND

### Technical Field

The present disclosure relates to an artificial intelligence-based industrial site work area minimum number-of-people control system, and more particularly, to an artificial intelligence-based industrial site work area minimum number-of-people control system which monitors the number of workers in an actual work area where equipment is disposed based on a camera image and controls equipment which produces products to operate when a minimum number of workers is detected in an industrial site work area set by a user.

### Description of the Related Art

Generally, in the industrial site, high voltage and current, high temperature, and chemicals are used to produce products or perform the works.

In such an industrial site, workers are exposed to risk factors, such as a high voltage and current and the worker's carelessness or negligence in management may lead to fatal accidents.

Accordingly, in order to prevent the fatal accidents in the industrial site, a buddy system which designates a minimum number of workers to perform the work as one group is being utilized.

According to the buddy system, even though one worker has an accident, another worker may take immediate action so that a major accident is prevented. Further, among actual fatal industrial accidents which have actually occurred, there are many accidents which can be prevented by the buddy system.

However, in the related art, there were problems that the buddy system was not utilized often due to decrease in work efficiency and lack of supervision by a manager and additional costs were incurred by assigning an additional person (manager) to supervise the buddy system.

Accordingly, it is necessary to establish a system which prevents the industrial safety accidents by controlling a minimum number of people in the work area in an industrial site, instead of the buddy system of the related art.

### RELATED ART DOCUMENT

### Patent Document

(Patent Document 1) Korean Registered Patent Publication No. 10-0854931 (registered on Aug. 22, 2008)

### SUMMARY

Accordingly, the present disclosure has been made to solve the problems as described above and an object of the present disclosure is to provide an artificial intelligence-based industrial site work area minimum number-of-people control system which monitors the number of workers in an actual work area where equipment is disposed based on a camera image and controls equipment which produces products to operate when workers equal to or more than a minimum number of people in an industrial site work area set by a user are detected.

Technical objects to be achieved by the present disclosure are not limited to the aforementioned technical objects, and another technical object which has not been mentioned will be clearly understood by those skilled in the art from the description below.

As a technical means to achieve the above-described objects, an artificial intelligence-based industrial site work area minimum number-of-people control system according to an exemplary embodiment of the present disclosure includes a camera which captures equipment which performs a process of producing products in an industrial site in real time to acquire real-time image data, a control unit which turns on or off the equipment, an image collection unit which collects the real-time image data acquired by the camera, an artificial intelligence inference unit which establishes an industrial site image dataset based on the real-time image data and trains, validates, and tests an artificial intelligence model to monitor a worker in the real-time image data based on the industrial site image dataset and calculate the number of workers detected by the monitoring, and a worker count unit which displays the real-time image data on a screen, sets an actual work area on the real-time image data displayed on the screen and an industrial site work area which encloses the actual work area, monitors a worker in the industrial site work area based on the artificial intelligence model, and calculates the number of workers detected by the monitoring, in which the worker count unit may transmit a first control request signal to the control unit when a first event in which a predetermined time has elapsed in a state in which the number of workers located in the industrial site work area is less than a predetermined minimum number of workers occurs.

Further, the artificial intelligence-based industrial site work area minimum number-of-people control system according to an exemplary embodiment of the present disclosure may further include a notification unit which outputs a first notification in accordance with a first notification request signal received from the control unit when the control unit receives the first control request signal.

The first notification may be output as a sound through at least one speaker, among a plurality of speakers disposed in an industrial site installed to be close to equipment which is a cause of the first event and may be output as a text on a screen of the worker count unit, simultaneously.

Further, when the occurrence of the first event is maintained until a predetermined period of time has elapsed after outputting the first notification so that the first control request signal is continuously received from the worker count unit, the control unit may terminate an operation of the equipment which is a cause of occurrence of the first event.

When a second event for an emergency situation in the industrial site occurs from the real-time image data displayed on the screen, the worker count unit may transmit a second control request signal to the control unit.

When the second control request signal is received from the worker count unit, the control unit may control an operation of the equipment in the industrial site to terminate the operation of the equipment and transmit a second notification request signal to the notification unit and the notification unit may output a second notification in accordance with the second notification request signal.

The second notification may be output as a sound through a main speaker, among a plurality of speakers disposed in the industrial site and may be output as a text on a screen of the worker count unit, simultaneously.

The camera may be at least one or a combination of two or more of a thermal imaging camera, a CCTV camera, and an infrared camera which are capable of capturing the equipment.

The camera may be connected to the image collection unit through a local area network to transmit the real-time image data.

Further, the artificial intelligence model may be YOLO V5 which is an object detection-based deep learning algorithm which is capable of monitoring the workers from the real-time image data.

According to the present disclosure, when a predetermined time has elapsed in a state in which the number of workers in an industrial site work area detected based on real-time image data of a camera is less than a predetermined minimum number of people or a dangerous situation, such as fire, occurs, a notification is output to provide information to both workers and managers in the industrial site and allow a rapid response.

Further, according to the present disclosure, real-time image data of the camera is monitored to maintain the number of workers in the industrial site work area to be equal to or more than a predetermined minimum number and big accidents on the industrial site may be prevented in advance by quick response of both the workers and the managers in the industrial site.

Further, according to the present disclosure, a system which terminates an operation of equipment which produces products when the number of workers in an industrial site work area detected based on real-time image data of a camera is less than a predetermined minimum number of people to prepare for the Serious Accident Punishment Act applied to industrial sites may be provided.

Effects to be achieved by the present disclosure are not limited to the aforementioned effects, and other effects which have not been mentioned will be obviously understood by those skilled in the art from the description below.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram of an artificial intelligence-based industrial site work area minimum number-of-people control system according to an exemplary embodiment of the present disclosure;

FIG. 2 is a view illustrating a screen of a terminal of a user;

FIG. 3 is a block diagram illustrating a type of an artificial intelligence model which is trained, validated, and tested in an artificial intelligence inference unit of a modified embodiment;

FIG. 4 is a view for explaining a method of displaying real-time image data by a worker count unit of a modified embodiment.

### DETAILED DESCRIPTION OF THE EMBODIMENT

Hereinafter, exemplary embodiments of the present disclosure will be described more fully with reference to the accompanying drawings for those skilled in the art to easily implement the present disclosure. Description of the present disclosure is just an exemplary embodiment for structural and functional description so that the scope of the present disclosure is not interpreted to be limited by the exemplary embodiment described in the specification. That is, the exemplary embodiment may be modified in various forms so that it is understood that the scope of the present disclosure has equivalents which are capable of implementing the technical spirit. Further, it does not mean that the specific exemplary embodiment includes the object or effect proposed in the present disclosure or includes only the effect so that it is not understood that the scope of the present disclosure is limited thereby.

In the meantime, meanings of terms described in the present disclosure can be understood as follows.

The terms “first” or “second” are used to distinguish one component from the other component so that the scope should not be limited by these terms. For example, a first component may be referred to as a second component, and similarly, a second component may be referred to as a first component. It should be understood that, when it is described that an element is “connected” to another element, the element may be directly connected to the other element or connected to the other element through a third element. In contrast, it should be understood that, when it is described that an element is directly connected to another element, no element is present between the element and the other element. Other expressions which describe the relationship between components, that is, “between” and “directly between”, or “adjacent to” and “directly adjacent to” need to be interpreted in the same manner.

Unless the context apparently indicates otherwise, it should be understood that terms “include” or “have” indicate that a feature, a number, a step, an operation, a component, a part or the combination thereof described in the specification is present, but do not exclude a possibility of presence or addition of one or more other features, numbers, steps, operations, components, parts or combinations thereof, in advance.

Unless they are contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present disclosure.

### Control System

Hereinafter, configurations of exemplary embodiments will be described in detail with reference to the accompanying drawings.

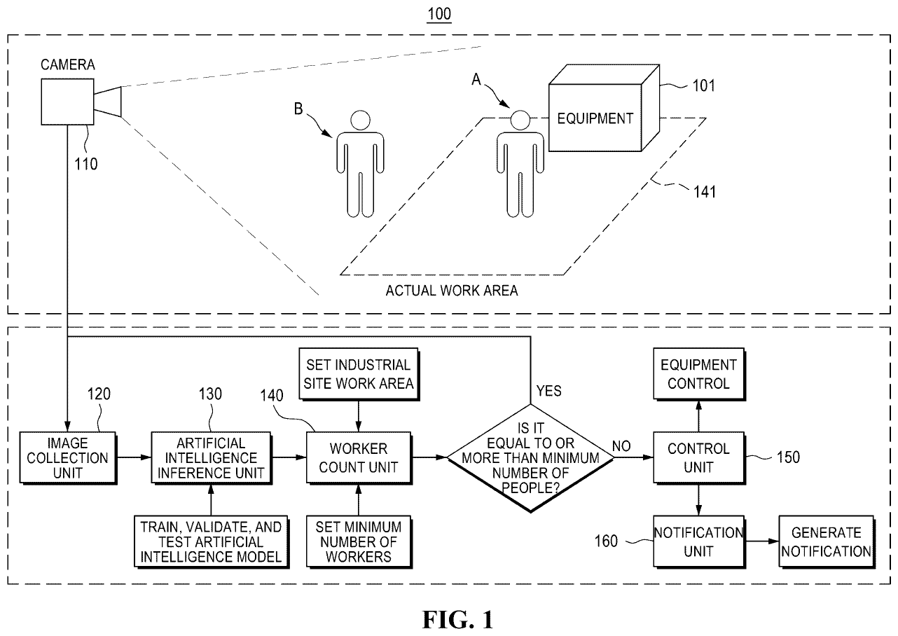

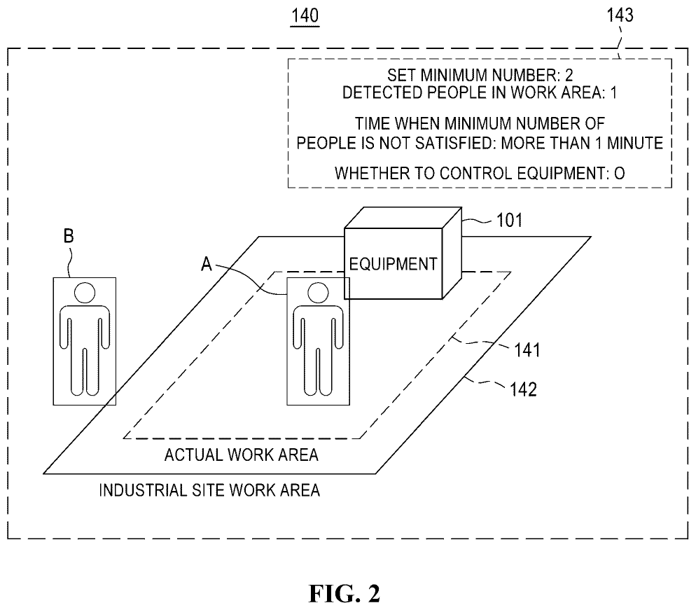

An artificial intelligence-based industrial site work area minimum number-of-people control system 100 according to an exemplary embodiment of the present disclosure (hereinafter, referred to as “control system”) is a system which controls an operation of equipment 101 depending on whether the number of workers in an actual work area 141 where equipment 101 performing a process of producing products is disposed is equal to or more than a minimum number of people set by a user and may include devices illustrated in FIGS. 1 and 2 to achieve the purpose.

FIG. 1 is a diagram of an artificial intelligence-based industrial site work area minimum number-of-people control system according to an exemplary embodiment of the present disclosure and FIG. 2 is a view illustrating a screen of a terminal of a user.

Referring to FIGS. 1 and 2, the control system 100 includes a camera 110, an image collection unit 120, an artificial intelligence inference unit 130, a worker count unit 140, a control unit 150, and a notification unit 160.

The camera 110 is disposed in a position to capture equipment 101 which performs a process of actually producing products by workers A and B in an industrial site in real time and captures the equipment 101 to acquire real-time image data.

In the exemplary embodiment, one or more equipment 101 are desirably installed in an industrial site to produce products by performing a specified process for producing products and each equipment 101 may be disposed in an actual work area 141 and may be connected to produce products.

In one exemplary embodiment, the actual work area 141 is an area which is generated on real-time image data which is displayed on a screen of the worker count unit 140. When two or more equipment 101 are disposed in the industrial area, the actual work area may be generated with respect to each equipment 101.

That is, the actual work area 141 may be desirably generated in a one-to-one ratio with the number of equipment 101.

Further, the actual work area 141 is an area enclosed by the industrial site work area 142 which is generated on real-time image data displayed on a screen of the worker count unit 140 and may be generated in a quadrangular shape to be easily enclosed by the industrial site work area 142. However, the shape of the actual work area 141 may be generated in at least one of polygonal shapes, such as a circle, a triangle, or a pentagon, in addition to the above-described quadrangular shape.

However, the actual work area 141 may be a virtual area which is generated by the worker count unit 140, but may be generated through a line drawn on a floor of an industrial area to be included in real-time image data which is acquired by the camera 110. However, the actual work area 141 of the exemplary embodiment will be assumed as a virtual area which is generated by the worker count unit 140.

The camera 110 of the exemplary embodiment is not illustrated in the drawing, but may include a detection unit (not illustrated) which detects the equipment 101 and a capturing unit (not illustrated) which adjusts a capturing timing based on the equipment 101 detected by the detecting unit (not illustrated) to capture a surrounding area of the equipment 101.

At this time, when the capturing unit (not illustrated) of the camera 110 captures the surrounding area of the equipment 101, it means that the surrounding area of the equipment 101 and workers A and B located in the surrounding area of the equipment 101 are captured in real time.

That is, the real-time image data acquired by the camera 110 may be image data including the equipment 101 and the workers A and B.

Further, a type of the camera 110 is not limited as long as it captures the equipment 101. According to the exemplary embodiment of the present disclosure, the camera may be provided as at least one or a combination of two or more of various types of cameras, such as a thermal imaging camera, a CCTV camera, and an infrared camera, depending on the characteristic of the industrial site.

If a plurality of equipment 101 is disposed in the industrial site to perform the process of producing products, the camera 110 is provided in plural as many as the total number of equipment 101 to capture each equipment 101.

As described above, one of the plurality of cameras 110 may capture one equipment 101, but two or more cameras 110 may be configured as one module to simultaneously capture one equipment 101 or may be separately installed to be adjacent to each other to simultaneously or sequentially capture one equipment 101.

At this time, two or more cameras 110 for capturing one equipment 101 may be the same type of cameras, but may be different types of cameras to receive various types of real-time image data from the image collection unit 120.

As a specific example, one of two cameras 110 for capturing one equipment 101 may be a CCTV camera and the other camera may be an infrared camera.

The real-time image data obtained by capturing the surrounding area of the equipment 101 by the camera 110 of the present disclosure may be transmitted to the image collection unit 120. The camera 110 may be connected to the image collection unit 120 via a local area network (Ethernet) to transmit real-time image data including the equipment 101 and the workers A and B to the image collection unit 120.

The image collection unit 120 may be a server which receives the real-time image data from the camera 110 through the local area network with the camera 110.

Further, the image collection unit 120 may transmit the real-time image data received from the camera 110 to the artificial intelligence inference unit 130 and the worker count unit 140.

The artificial intelligence inference unit 130 may establish an industrial site image dataset based on real-time image data received from the image collection unit 120.

At this time, the industrial site image dataset may be divided into a training dataset for training an artificial intelligence model, a validation dataset for validation, and a test dataset for evaluating a performance of an artificial intelligence model.

As described above, the artificial intelligence model which is trained, validated, and tested by the artificial intelligence inference unit 130 to have ensured performance may be configured (or loaded) in the worker count unit 140 to allow the worker count unit 140 to monitor the workers A and B in the real-time image data and calculate the number of workers A and B detected by the monitoring.

Further, when the performance of the artificial intelligence model is ensured, it means that a performance of monitoring the workers A and B from the real-time image data is ensured.

The artificial intelligence model of the exemplary embodiment may be a model which is trained in advance from the real-time image data and may be a you only look once (YOLO) algorithm-based artificial intelligence model which is an object detection-based deep learning algorithm to monitor the workers A and B from the real-time image data, and more specifically, may be a YOLO V5-based artificial intelligence model.

In the exemplary embodiment, the artificial intelligence model labels the workers A and B in the real-time image data to establish the training dataset while performing the process of training through the industrial site dataset to be trained based thereon.

The worker count unit 140 is a terminal (for example, a computer, a tablet, a mobile phone, or a smart phone) of a user who is a manager of the control system 100 and may monitor workers A and B from the real-time image data which is received from the image collection unit 120 based on the above-described artificial intelligence model and calculate the number of workers A and B detected by the monitoring.

Further, when the worker count unit 140 calculates the number of workers A and B in the real-time image data, the worker count unit 140 may also calculate the number of workers A located in the industrial site work area 142 together.

As described above, in order for the worker count unit 140 to calculate the number of workers A located in the industrial site work area 142 together, the industrial site work area 142 needs to be set and before setting the industrial site work area 142, an actual work area 141 needs to be set.

Further, the worker count unit 140 may set the actual work area 141 with respect to the equipment 101 included in the real-time image data which is received from the image collection unit 120 by the manipulation of the user and then set the industrial site work area 142 with respect to the set actual work area 141.

In one exemplary embodiment, the actual work area 141 may be a virtual area set based on the work area of the worker A which is predicted by the worker count unit 140 while operating the equipment 101 in an on-state to perform the product-producing process, as displayed on the screen of the worker count unit 140 illustrated in FIG. 2.

In the exemplary embodiment, the industrial site work area 142 is a virtual area which is larger than the actual work area 141 so that it may be set by the worker count unit 140 to enclose the actual work area 141, as displayed on the screen of the worker count unit 140 illustrated in FIG. 2.

Further, the industrial site work area 142 may be set to have the same shape as the actual work area 141 by the worker count unit 140. However, in the exemplary embodiment, as illustrated in FIG. 2, the industrial site work area 142 is larger than the actual work area 141 to be set to enclose the actual work area 141.

At this time, the industrial site work area 142 is larger than the actual work area 141 to be set to enclose the actual work area 141 to distinguish the actual work area 141 from the industrial site work area 142 on the screen of the worker count unit 140.

Further, the actual work area 141 and the industrial site work area 142 may be displayed with lines with different sizes to allow a user to easily distinguish from each other in the real-time image data which is output on the screen of the worker count unit 140.

As a specific example, the actual work area 141 may be displayed with a dotted line in the real-time image data displayed on the screen of the worker count unit 140 and the industrial site work area 142 may be displayed with a solid line in the real-time image data displayed on the screen. The actual work area 141 and the industrial site work area 142 may be displayed with different color lines.

As described above, when the setting of the actual work area 141 and the industrial site work area 142 is completed, the worker count unit 140 monitor workers A and B in the real-time image data displayed on the screen and calculate the number of workers A located in the industrial site work area 142, between workers A and B detected by the monitoring.

Hereinafter, it is assumed that a worker A who is located inside the industrial site work area 142 to manipulate the equipment 101 is referred to as a first worker A and a worker B who is located out of the industrial site work area 142 is referred to as a second worker B.

Further, when the worker count unit 140 of the present disclosure calculates the number of first workers A located in the industrial site work area 142, it is determined whether the calculated number of first workers A is equal to or more than a predetermined minimum number of workers.

At this time, when an event that a predetermined time has elapsed in a state in which the number of first workers A located in the industrial site work area 142 from the worker count unit 140 is less than the minimum number of workers occurs, the worker count unit 140 may transmit a control request signal to the control unit 150 which controls the operation of the equipment 101 to stop the operation of the equipment 101 located in the industrial site work area 142 together with the first worker A.

In contrast, when a state in which the number of first workers A located in the industrial site work area 142 is equal to or more than the predetermined minimum number of workers from the worker count unit 140 is maintained so that an event does not occur, the worker count unit 140 may omit the process of transmitting the control request signal to the control unit 150 and monitor each of the first worker A and the second worker B in the real-time image data received from the image collection unit 120.

In the present disclosure, the predetermined minimum number of workers and the predetermined time may be set by a user of the worker count unit 140.

Further, in the present disclosure, the event includes not only an event occurring when a predetermined time has elapsed in a state in which the number of first workers A located in the industrial site work area 142 is less than the predetermined minimum number of workers (hereinafter, “first event”), but also an event when an emergency situation, such as fire, occurs in the industrial site (hereinafter, “second event”).

When the emergency situation such as fire (second event) occurs in the real-time image data displayed on the screen, the worker count unit 140 of the present disclosure may detect whether the second event occurs and to this end, the artificial intelligence model is trained, validated, and tested to ensure the performance so as to not only monitor the workers A and B, but also monitor (detect) whether the second event occurs.

When at least one of the first event and the second event occurs, the worker count unit 140 transmits the control request signal to terminate (off) the operation of the equipment 101 which operates in an on-state to produce products, to the control unit 150.

To be more specific, the worker count unit 140 may continuously transmit a first control request signal to the control unit 150 while the first event occurs and when an emergency situation, such as fire, is detected from the real-time image data so that the second event occurs, transmit a second control request signal to the control unit 150.

As illustrated in FIG. 2, the worker count unit 140 of the present disclosure may display control information 143 including a predetermined minimum number of workers which is a criterion for transmitting a control request signal on the screen.

The control information 143 of the exemplary embodiment may be information including a minimum number of workers set in advance in the worker count unit 140 by means of the manipulation of the user, the number of workers located in the industrial site work area 142 set in the worker count unit 140 by means of the manipulation of the user, a time when a state in which the number of workers located in the industrial site work area 142 is maintained to be less than the minimum number of workers, and whether the control unit 150 controls the equipment 101 located in the industrial site work area 142.

Further, as the control information 143, the predetermined minimum number of workers and the number of workers located in the industrial site work area 142 may be represented with numbers. The time when the number of workers located in the industrial site work area 142 is maintained to be less than the minimum number of workers may be represented as minutes or seconds and whether the time when the number of workers is maintained to be less than the minimum number of workers exceeds a predetermined time may be represented with texts. Whether the control unit 150 can control the equipment 101 may be represented by “O” or “X”.

In the meantime, when two or more equipment 101 are installed in the industrial site, the image collection unit 120 may generate a plurality of real-time image data received from the camera 110 and transmit the plurality of real-time image data to the artificial intelligence inference unit 130 and the worker count unit 140.

The worker count unit 140 of the present disclosure, as illustrated in FIG. 2, has been described that the actual work area 141 and the industrial site work area 142 set with respect to one equipment 101 and the control information 143 are displayed on the screen. However, a displaying method may be set to display separately the plurality of real-time image data received from the image collection unit 120 on the screen, like a CCTV split screen.

The control unit 150 is a control device which turns on or off an operation of each equipment 101 which performs a product-producing process and one or more control units may be disposed in the industrial site.

When at least one event of the first event and the second event occurs to receive a first control request signal or a second control request signal from the worker count unit 140, the control unit 150 may transmit a notification request signal to the notification unit 160 to output a notification.

To be more specific, when the first control request signal is received from the worker count unit 140, the control unit 150 may transmit the first notification request signal to the notification unit 160 and when the second control request signal is received from the worker count unit 140, the control unit 150 may transmit the second notification request signal to the notification unit 160.

When the first notification request signal is received from the control unit 150, the notification unit 160 outputs a first notification.

At this time, the first notification may be output to be perceived by the workers A and B in the vicinity of the equipment 101 which causes the first event and the user of the worker count unit 140.

To be more specific, the first notification may be output as a sound through at least one speaker, among a plurality of speakers (not illustrated) disposed in the industrial site installed to be closer to the equipment 101 which causes the first event and also output as a test on the screen of the worker count unit 140.

The first notification is simultaneously output from the speaker (not illustrated) and the worker count unit 140 to take immediate action in the industrial site and allow the user of the worker count unit 140 who is a manager to identify the situation of the industrial site.

When the control unit 150 of the present disclosure continuously receives the first control request signal from the worker count unit 140 because the number of workers A located in the industrial site work area 142 is not equal to or more than the predetermined minimum number of workers until a predetermined period of time has elapsed after outputting the first notification from the notification unit 160 so that occurrence of the first event is maintained, the control unit 150 controls the operation of the equipment 101 located in the industrial site work area 142 which is a cause of the first event to terminate (off) the operation of the equipment 101.

In the meantime, when the second control request signal is received from the worker count unit 140, the control unit 150 controls the operations of all equipment 101 in the industrial site to terminate (off) the operations of all the equipment 101 and transmit the second notification request signal to the notification unit 160.

When the second notification request signal is received from the control unit 150, the notification unit 160 of the present disclosure outputs a second notification.

At this time, the second notification may be output to be perceived by all the workers A and B in the industrial site of the second event and the user of the worker count unit 140.

To be more specific, the second notification may be output as a sound through a main speaker (not illustrated) among a plurality of speakers (not illustrated) disposed in the industrial site and output as a test on the screen of the worker count unit 140, simultaneously.

At this time, the main speaker (not illustrated) refers to one predetermined speaker, among speakers (not illustrated) identified by the control unit 150 and may be a speaker which is disposed in the industrial site to be used to transmit a notice about the process for producing products in normal times and induce evacuation of workers A and B of the industrial site when the second event occurs.

The second notification is simultaneously output from the main speaker (not illustrated) and the worker count unit 140 to respond to the emergency situation in the industrial site and allow the user of the worker count unit 140 who is a manager to identify the situation of the industrial site and request the help from the outside (fire station), and induce the evacuation of the workers A and B in the industrial site.

When a predetermined time has elapsed in a state in which the number of workers in an industrial site work area 142 detected based on real-time image data of the camera 110 is less than a predetermined minimum number of people or a dangerous situation, such as fire, occurs, the control system 100 of the present disclosure outputs a notification to provide information to both workers and managers in the industrial site and allow a quick response.

Further, the control system 100 of the present disclosure monitors real-time image data of the camera 110 to maintain the number of workers A in the industrial site work area 142 to be equal to or more than a predetermined minimum number of people and prevent big accidents on the industrial site by quick response of both the workers and the managers in the industrial site.

Further, when the number of workers A in the industrial site work area 142 detected based on real-time image data of the camera 110 is less than a predetermined minimum number of people, the control system 100 of the present disclosure terminates an operation of equipment 101 which produces products to provide a system which may prepare for the Serious Accident Punishment Act applied to industrial sites.

### Modified Embodiment

Hereinafter, a control system 100 of a modified embodiment in which the above-described control system 100 of the exemplary embodiment is modified will be described in detail and a repeated description with the above-described control system 100 of the exemplary embodiment will be omitted for the sake of convenience.

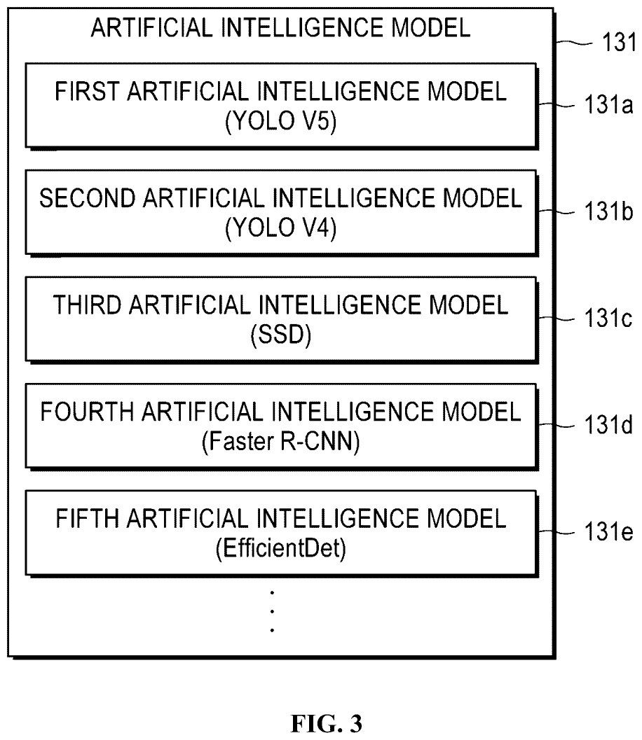

FIG. 3 is a block diagram illustrating a type of an artificial intelligence model which is trained, verified, and tested in an artificial intelligence inference unit of a modified embodiment.

Referring to FIG. 3, the artificial intelligence inference unit 130 of the modified embodiment may train, validate, and test not only a YOLO V5-based artificial intelligence model 131a (hereinafter, “first artificial intelligence model”) which has been described above in the exemplary embodiment, but also a YOLO V4-based artificial intelligence model 131b (hereinafter, “second artificial intelligence model”), a signal shot multibox detector (SSD)-based artificial intelligence model 131c (hereinafter, “third artificial intelligence model”), a faster R-CNN (region-based convolutional neural network)-based artificial intelligence model 131d (hereinafter, “fourth artificial intelligence model”, and an efficientDet based artificial intelligence model 131e (hereinafter, “fifth artificial intelligence model”).

That is, the artificial intelligence inference unit 130 of the modified embodiment may train, validate, and test the above-described first to fifth artificial intelligence model based on an industrial site image dataset established through the real-time image data received from the image collection unit 120.

Further, whenever the real-time image data is received from the image collection unit 120, the artificial intelligence inference unit 130 of the modified embodiment may update the industrial site image dataset by adding the real-time image data to the industrial site image dataset and may train, validate, and test the first to fifth artificial intelligence models through the updated industrial site image dataset, and may detect an artificial intelligence model with the most excellent performance, among the first to fifth artificial intelligence models, through the test.

At this time, if the artificial intelligence inference unit 130 detects an artificial intelligence model which has a different format from the artificial intelligence models configured in the worker count unit 140 to have the most excellent performance, the artificial intelligence inference unit 130 may perform a task to exchange (update) the artificial intelligence model configured in the worker count unit 140 to the artificial intelligence model with the most excellent performance to allow the worker count unit 140 to monitor the workers A and B in the real-time image data and accurately calculate the number of workers A and B detected by the monitoring.

Even though in the modified embodiment, the artificial intelligence model which is trained, validated, and tested by the artificial intelligence inference unit 130 is described to be limited to the first to fifth artificial intelligence models, the artificial intelligence model is not limited thereto and an object detection algorithm-based artificial intelligence model to monitor the workers A and B and measure the number of workers A and B detected by the monitoring may be added.

Further, the artificial intelligence inference unit 130 of the modified embodiment may train, validate, and test not one artificial intelligence model, but two or more artificial intelligence models to be configured in the worker count unit 140 to ensure the performance.

In this case, the worker count unit 140 of the modified embodiment may monitor the worker A in the industrial site work area 142 and calculate the number of workers A detected by the monitoring based on two or more artificial intelligence models.

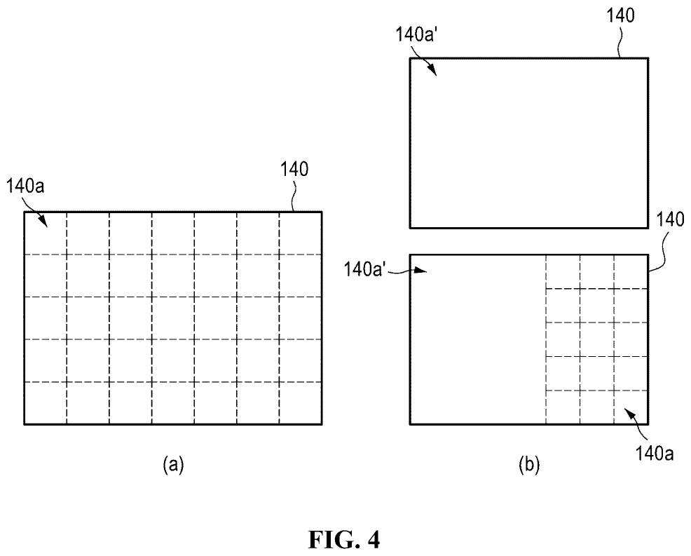

FIG. 4 is a view for explaining a method of displaying real-time image data by a worker count unit of a modified embodiment.

Referring to FIG. 4A, the worker count unit 140 of the modified embodiment may separately display the plurality of real-time image data 140a like a CCTV split screen. When a first event that a predetermined time has elapsed in a state in which the number of first workers A located in the industrial site work area 142 displayed in specific real-time image data 140a′, among a plurality of real-time image data 140a, is less than a predetermined minimum number of workers occurs so that a first notification is output from the specific real-time image data by the notification unit 160, as illustrated in FIG. 4B, the real-time image data 140a′ from which the first notification is output may be enlarged to be displayed on the screen of the worker count unit 140.

Referring to FIG. 4B, when the worker count unit 140 of the modified embodiment enlarges to display the real-time image data 140a′ from which the first notification is generated, it means that only the real-time image data 140a′ which is a cause of the first event is displayed on the screen of the worker count unit 140 or the real-time image data 140a′ which is a cause of the first event is displayed on the screen of the worker count unit 140 to be larger than the remaining real-time image data 140a in which no event occurs.

The method of separately displaying the real-time image data 140a in accordance with the output of the first notification on a screen of the worker count unit 140 of the modified embodiment may be applied to the case when the second notification is output to specific real-time image data 140a′, among the real-time image data 140a, in the same way.

As described above, the detailed description of the preferred exemplary embodiments of the disclosed present disclosure is provided such that those skilled in the art implement and carry out the present disclosure. While the disclosure has been described with reference to the preferred exemplary embodiments, it will be understood by those skilled in the art that various changes and modifications of the present disclosure may be made without departing from the spirit and scope of the disclosure. For example, those skilled in the art may use configurations disclosed in the above-described exemplary embodiments by combining them with each other. Therefore, the present disclosure is not intended to be limited to the above-described exemplary embodiments but to assign the widest scope consistent with disclosed principles and novel features.

The present disclosure may be implemented in another specific form within the scope without departing from the technical spirit and essential feature of the present disclosure. Therefore, the detailed description should not restrictively be analyzed in all aspects and should be exemplarily considered. The scope of the present disclosure should be determined by rational interpretation of the appended claims and all changes are included in the scope of the present disclosure within the equivalent scope of the present disclosure. The present disclosure is not intended to be limited to the above-described exemplary embodiments but to assign the widest scope consistent with disclosed principles and novel features. Further, claims having no clear 10 quoting relation in the claims are combined to configure the exemplary embodiment or may be included as new claims by correction after application.

What is claimed is:

1. An artificial intelligence based industrial site work area minimum number-of-people control system, comprising:
a camera which captures equipment which performs a process of producing products in an industrial site in real time to acquire real-time image data;
a control unit which turns on or off the equipment;
an image collection unit which collects the real-time image data acquired by the camera;
an artificial intelligence inference unit which establishes an industrial site image dataset based on the real-time image data and trains, validates, and tests an artificial intelligence model to monitor a worker in the real-time image data based on the industrial site image dataset and calculate the number of workers detected by the monitoring; and
a worker count unit which displays the real-time image data on a screen, sets an actual work area on the real-time image data displayed on the screen and an industrial site work area which encloses the actual work area, monitors the worker in the industrial site work area based on the artificial intelligence model, and calculates the number of workers detected by the monitoring,
wherein the worker count unit transmits a first control request signal to the control unit when a first event in which a predetermined time has elapsed in a state in which the number of workers located in the industrial site work area is less than a predetermined minimum number of workers occurs.

2. The artificial intelligence based industrial site work area minimum number-of-people control system according to claim 1, further comprising:
a notification unit which outputs a first notification in accordance with a first notification request signal received from the control unit when the control unit receives the first control request signal.

3. The artificial intelligence based industrial site work area minimum number-of-people control system according to claim 2, wherein the first notification is output as a sound through at least one speaker, among a plurality of speakers disposed in the industrial site installed to be close to the equipment which is a cause of the occurrence of the first event and is output as a text on the screen of the worker count unit, simultaneously.

4. The artificial intelligence based industrial site work area minimum number-of-people control system according to claim 2, wherein when the occurrence of the first event is maintained until a predetermined period of time has elapsed after outputting the first notification so that the first control request signal is continuously received from the worker count unit, the control unit terminates an operation of the equipment which is a cause of the occurrence of the first event.

5. The artificial intelligence based industrial site work area minimum number-of-people control system according to claim 2, wherein when a second event for an emergency situation in the industrial site occurs from the real-time image data displayed on the screen, the worker count unit transmits a second control request signal to the control unit.

6. The artificial intelligence based industrial site work area minimum number-of-people control system according to claim 5, wherein when the second control request signal is received from the worker count unit, the control unit controls an operation of the equipment in the industrial site to terminate the operation of the equipment and transmits a second notification request signal to the notification unit and the notification unit outputs a second notification in accordance with the second notification request signal.

7. The artificial intelligence based industrial site work area minimum number-of-people control system according to claim 6, wherein the second notification is output as a sound through a main speaker, among a plurality of speakers disposed in the industrial site and is output as a text on the screen of the worker count unit, simultaneously.

8. The artificial intelligence based industrial site work area minimum number-of-people control system according to claim 1, wherein the camera is at least one or a combination of two or more of a thermal imaging camera, a CCTV camera, and an infrared camera which are capable of capturing the equipment.

9. The artificial intelligence based industrial site work area minimum number-of-people control system according to claim 1, wherein the camera is connected to the image collection unit through a local area network to transmit the real-time image data.

10. The artificial intelligence based industrial site work area minimum number-of-people control system according to claim 1, wherein the artificial intelligence model is YOLO V5 which is an object detection-based deep learning algorithm which is capable of monitoring the workers from the real-time image data.
